(19) United States
(12) Patent Application Publication
(10) Pub. No.: US 2010/0074998 A1
(43) Pub. Date: Mar. 25, 2010

(54) Meat Substitute Food Product And Process For Preparing The Same

(76) Inventors: Alicia Espeleta Vega, Monterrey (MX); Cesar Dalmacio Mora Castillo, Tultepec (MX)

Correspondence Address: BRACEWELL & GIULIANI LLP, P.O. BOX 61389, HOUSTON, TX, 77208-1389, US

(21) Appl. No.: 12/513,177

(22) PCT Filed: Nov. 1, 2007
(86) PCT No.: PCT/MX2007/000133

§ 371 Date: May 1, 2009

(30) Foreign Application Priority Data
Nov. 1, 2006 (MX) NL/A/2006/000083

(51) Int. Cl. A23L 1/31; A23L 1/275; A23L 1/314; A23L 1/317; A23L 1/318; A23P 1/08; A23P 1/12

(52) U.S. Cl. 426/92; 426/250; 426/574; 426/540

(57) ABSTRACT

A process for preparing meat substitute food products, including the steps of hydrating under vacuum of at least one vegetable protein mixed with water and at least one colorant; mixing at least one meat product with the hydrated and colored vegetable protein mixture; mixing flavoring units and texturised units into the mixture of meat products and hydrated and colored vegetable protein, thus obtaining a prepared paste; cooking said prepared paste; and shaping said cooked paste to produce an appearance similar to a meat product. The substitute meat food product obtained according to the invention can have the appearance, for example, of example, to steak, cutlet, skirt steak, cured steak, breaded veal cutlet, breaded skirt steak, veal escalope, a shredded meat, ground meat, lump meat, meat strips or meatballs.

### 1. TECHNICAL FIELD OF THE INVENTION

At present meat substitute food products are prepared, generally, from the combination of animal protein and vegetable protein. The acceptance of these products by consumers is directly related to the organoleptic qualities such as texture, taste, sensation in the mouth and appearance.

### 2. BACKGROUND OF THE INVENTION

The term texture describes a wide range of physical properties of a food product. A food product of acceptable texture is usually synonymous with the quality of the product. The texture has been defined as “the attribute of a substance resulting from a combination of physical properties and which is perceived by touch, the sense of taste, sight and hearing.” The International Organization for Standardization defines the term texture as “all the theological and structural attributes (geometry and surface) of a food product that are perceived through mechanical receptors, touch and, where appropriate, through visual and auditory receptors.

The texture has received an accelerated importance in the preparation and manufacture of imitation products, meat analogues or substitutes, where very serious efforts are made to duplicate the properties of the original food substance. The use of non-traditional raw materials, synthetic flavors, fillers and stretchers all tend to alter certain textural characteristics of the finished product. Frequently, the imitation of textural properties is of much greater difficult in the replication of taste, odors, and colors. Many manipulation processes, including extrusion and texturization, have been developed to simulate properties of natural texture to give greater market acceptance of products similar to meat. It has to be taken into account that the texture-related attributes involves the appearance, the touch and the feel in the mouth, and even the interaction between the products similar to meat with the mouth, as a proper sense of mastication by the consumer, is directly related to the acceptance or not of the meat substitute product.

The microstructure of a meat substitute determines whether the substitute has a similar quality to the meat as to texture, moisture, flavor to the palate and tenderness.

At macroscopic level, some natural meat has muscle fibers that are visually perceptible; they have a cylindrical shape and are parallel. La microstructure of these fibers contains microfibrils with a diameter in the range of microns and they are also cylindrical and parallel.

The substitutes for meat products obtained by the current processes are different from natural beef in several important qualities. These products are different from meat because they lack the fiber and microfibrilar structures of meat. Their similarity with meat is only superficial and they have not been widely accepted by the public.

Examples of the current solutions to provide imitation products, meat substitutes or analogues with similar texture to an original meat product are described in the following patent documents.

Albert Spiel, in the U.S. Pat. No. 4,057,656 describes a method for preparing quick cooking foods that are tasty chewable chunks, soft, light in color and of a meat-type texture, when hydrated. The method consists of pressing the vegetable protein material containing 30% or more of protein, 5% to 10% moisture content and a nitrogen solubility index of 30 to 70 at a temperature sufficient to convert the moisture into steam. The result is that the protein material is partially or substantially soft.

Edward M. McCabe, in the Mexican patent MX-165467, describes a method for processing whole soyas to produce discrete chunks or pieces of an irregular shape of texturised proteinic material that are free of odors and flavors and have an appearance and meat-type texture. The method consists of acidifying whole soyas, grinding them in an aqueous medium to provide an aqueous suspension or a mass of soybean particles, which is passed through a pressurized steam at high temperature under the conditions that make the texturised soy protein in the form of discrete pieces or chunks. The texturised pieces are dried and rehydrated for use in a wide variety of food product. Some additives may be incorporated such as appetizers, colorings, fat, condiments and other proteinic materials, in the pieces of texturised soy protein.

Albert Monferrer Ballester, in the publication of Spanish patent application ES-2,102,974 describes a procedure for obtaining food products similar to meat or fish. The procedure is based on a mass formed by a mixture of meat or fish with ingredients and food additives such as water, salt, starch, flour, proteins, stabilizers and others, where the internal jellification is originated by combining in the mass product prepared with a soluble salt of alginic acid, a soluble calcium salt and a pH modifier.

Paul Hargarten, in the publication of the Mexican patent application MX PA04006552 describes a process for preparing a vegetable based meat analogue. Said meat analogue can be used in a variety of vegetarian foods such as fried ground beef sandwiches and stuffed meats, the procedure involves mixing methylcellulose in a mixture of water and ice to form a cream, then blending in a modified gluten a vegetable protein product that has a high solubility in water and is capable of forming a gel under a mild heat treatment, an oil to obtain an emulsion base, and a modified food starch and flavoring ingredients to form a base of a seasoned emulsion; the base of the seasoned emulsion can be stuffed in wrappings, and then be cooked; the meat imitation based on the cooked emulsion has a high resemblance to processed meat products, with improved handling properties; the addition of the meat analogue emulsion based in vegetarian food helps improve the texture, feel in the mouth and juiciness.

Matthew K. McMindes, Mitchell A. Kaestner and Michael W. Finfrock, in the publication of U.S. patent application US-2006/0035003 describe a food product based on soy protein formed by a soy protein material selected from soy protein flour, soy protein concentrate, isolate from soy protein and mixtures thereof; a humectant formed by a colorant and at least one of any of the following substances: a flavor agent, a triglyceride, an acid or acid salt of food grade, a base or base salt of food grade, and an emulsion of food grade, and water. Chunks of meat can be added to the food product based on soy protein.

Matthew K. McMindes and Eduardo Godinez, in the publication of the U.S. patent application US-2006/0035005 describe a product of restructured meat that comprises a fibrous material that contains soy protein and fiber of cotyledon soy, wherein the latter contains an amount of 1% to 8% in weight in a base free of humidity; chunks of meat and water. The preparation process consists of hydrating a fibrous material that contains soy protein and cotyledon soy fiber, adding chunks of meat with a temperature below 10° C., and mixing the fibrous material and the meat chunks to produce a product of homogeneous and texturised meat that has a moisture content of at least 50%.

The state of the art described above involves limitations in a food industry where the texture of the product and its cost are very important, therefore, it is necessary to provide a meat substitute food product and processes for preparing the same, so that the food product obtained has macrofibers with a meat form, and preferably also microfibrils similar to meat and involves attributes of texture related to the appearance, the touch and the feel in the mouth and even the interaction of the analogue product with the mouth, as well as a taste, an odor and a color similar to meat.

### SUMMARY OF THE INVENTION

Referring to the aforementioned and with the aim of finding solutions to the limitations encountered, it is the object of the invention to provide a process for preparing food substitutes for meat, the process comprises the steps of hydrating in a vacuum at least one vegetable protein mixed with water and at least one colorant, mixing at least one meat product with the mixture of hydrated and colored vegetable protein; mixing units of texturised material to the mixture of meat products and hydrated and colored vegetable protein obtaining a prepared food paste; cooking the prepared paste, and forming said cooked paste to give a presentation similar to a meat product.

An alternative embodiment for cooking the prepared paste can be performed by rolling and cooking in a manner generally simultaneous and homogeneous said dosified paste, as well on its upper and lower surface in an oven including at least one upper heating panel and at least one lower heating panel, both panels being in contact with said paste to obtain the color and texture of meat.

Another alternative embodiment for cooking the prepared paste is extruding or molding said prepared paste, so that the fibers of said prepared paste are oriented in a similar manner as the orientation of the fibers of meat; and frying, or frying and cooking the extruded or molded paste for obtaining the color and texture of meat.

Another alternative embodiment for cooking the prepared paste is stuffing said prepared paste; cooking said stuffed paste in an oven or cook kettle; forming the cooked paste; and frying the formed paste.

It is also an alternative embodiment for cooking the prepared paste is cooking the prepared paste in a cooking pot by stirring it.

Also the object of the invention is a paste for preparing substitute meat food products, wherein the paste comprising at least one hydrated vegetable protein, at least one colorant, at least one meat product, and flavoring and texturising units.

Another object of the invention is to provide a process for preparing a paste for preparing a food substitute for meat, the process comprises the steps of hydrating under vacuum at least one vegetable protein mixed with water and at least one colorant; mixing at least one meat product with the mixture of hydrated and colored vegetable protein; and mixing texturised units of the mixture of meat products and hydrated and colored vegetable protein, thus obtaining a prepared paste.

Finally, the object of the invention is also a cooked meat substituted food product, where the product contains at least one hydrated vegetable protein, at least one colorant, at least one meat product, and flavoring units and texturing units.

The substitute meat food product obtained according to the invention may present an appearance, for example, of steak, cutlet, skirt steak, cured steak, breaded veal cutlet, breaded skirt steak, veal escalope, shredded meat, ground meat, lump meat, meat strips, or meatballs.

### BRIEF DESCRIPTION OF THE DRAWINGS

The present application file contains at least one drawing executed in color. Copies of this patent or patent application with color drawing(s) will be provided by the Office upon request and payment of the necessary fee.

The characteristic details of the present invention are described in the following paragraphs, together with the figures related to it, in order to define the invention, but not limiting the scope of it.

FIG. 1 is a block diagram of a process for preparing a paste for meat substitute food products according to this invention.

FIG. 2 is a block diagram of a first embodiment of a process for cooking the prepared paste in the process of FIG. 1 according to this invention.

FIG. 3 shows a color photograph of a cooked portion, according to the process of FIG. 2, of a meat substitute food product according to the invention.

FIG. 4 shows a photograph under an electronic microscope amplified to 100× of a view of a meat substitute food product according to the invention.

FIG. 5 is a block diagram of a second embodiment of a process for cooking the prepared paste in the process of FIG. 1 according to this invention.

FIG. 6 is a block diagram of a third embodiment of a process for cooking the prepared paste in the process of FIG. 1 according to this invention.

FIG. 7 is a block diagram of a fourth embodiment of a process for cooking the prepared paste in the process of FIG. 1 according to this invention.

FIG. 8 is a block diagram of a fifth embodiment of a process for cooking the prepared paste in the process of FIG. 1 according to this invention.

FIG. 9 is a block diagram of alternative embodiments of the processes for forming the prepared paste for the processes described in FIGS. 2, 5, and 8 in order to give a similar presentation of meat products according to this invention.

FIG. 10 is a block diagram of alternative embodiments of the processes for forming the prepared paste for the process described in FIG. 6, and in order to give a similar presentation of meat products according to this invention.

FIG. 11 is a block diagram of alternative embodiments of the processes for forming the cooked paste for the process described in FIG. 7, and in order to give a similar presentation of meat products according to this invention.

### DETAILED DESCRIPTION OF THE PREFERRED EMBODIMENTS

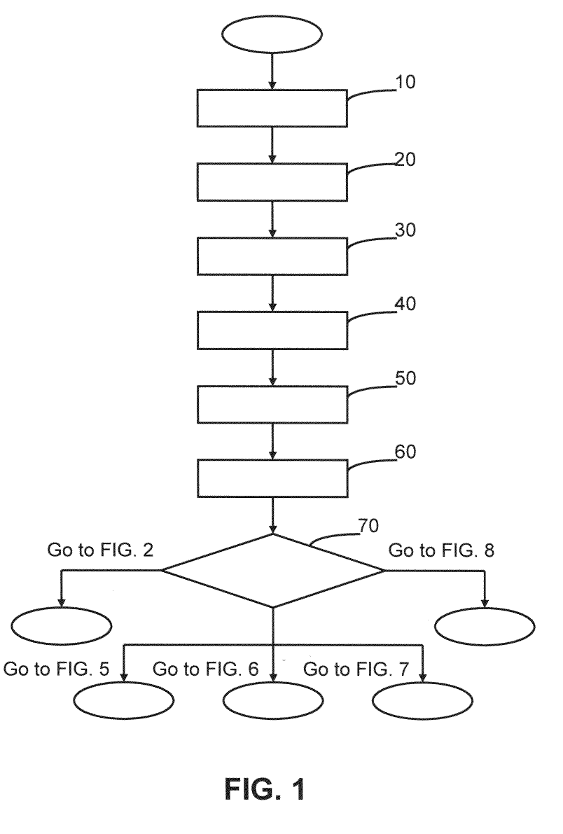

Referring to FIG. 1, a process is shown to prepare a paste for meat substitute products, where the process starts in step 10, in which a vegetable protein, of the fibrous or texturised type, whether extruded or hydrated in the form of concentrated proteinic, isolate flour, pellet, or combinations thereof, is mixed with a colorant, preferably of caramel color, and with water. The mixture and hydratation is performed under vacuum in an interval of a range of 40 to 80 minutes and at a pressure within the range of −100 kPa to −50 kPa, in a mixer with paddles rotating clockwise within the range of 10 min-1 to 20 min-1, and counterclockwise each turn within the range of 2 to 10 minutes. This type of mixing and hydratation under vacuum with a reduced number of turns of the paddles of the mixer, allows protecting the fibers or sinews of the vegetable protein used.

Subsequently, the mixture of hydrated and colored vegetable protein is mixed with at least one meat product. The meat product may be, for example, meat chunks or minced beef, pork, turkey or chicken, giblets in chunks or chopped beef, pork, turkey or chicken, mechanically deboned meat, such as beef, pork, turkey or chicken, and mixtures thereof. The meat products together with preservatives, salt and sodium nitrite are added in a dose during mixing. This mixture is made in two stages, the first mixing stage, step 20, is performed during a period within the range of 15 to 45 minutes in a mixer with paddles with an open lid, where the paddles rotating clockwise within the range of 10 min-1 to 20 min-1, and counterclockwise each turn within the range of 2 to 10 minutes; then, a second mixing stage is started, in step 30, in a period within the range of 10 to 20 minutes and at a pressure within a range from −100 kPa to −50 kPa in the mixer with the lid closed, but with the paddles turning clockwise within the range of 20 min-1 to 40 min-1, and counterclockwise each turn within the range of 2 to 10 minutes. This two-stage mixing and dosage of the ingredients allows extracting the major amount of protein from the meat products used.

Once the hydrated and colored, vegetable protein has been mixed with the meat products, it is mixed with texturised units in order to obtain a prepared paste. This mixture is blended in three stages: the first stage of mixing, step 40, consists of mixing, during a period within the range of 5 to 20 minutes, the mixture of meat products and hydrated and colored vegetable protein with said texturised units in a mixer with the lid closed, and whose paddles rotate clockwise within the range of 10 min-1 to 20 min-1, and counterclockwise each turn within the range of 2 to 10 minutes; then proceeds to perform a second mixing stage, step 50, consisting of mixing for a period within the range of 3 to 10 minutes in the mixer with the paddles rotating clockwise within the range of 20 min-1 to 40 min-1, and counterclockwise each turn within the range of 2 to 10 minutes; then proceeds to a third mixing step, step 60, consisting of mixing under vacuum for a period from 10 to 20 and at a pressure within a range from −100 kPa to −50 kPa in the mixer, but with the paddles rotating clockwise within the range of 20 min-1 to 40 min-1, and counterclockwise each turn within the range of 2 to 10 minutes. Alternatively, during step 40, flavoring units are added in a dosed manner, which can be, for example, units with a flavor of meat, pork, turkey or chicken, and combinations thereof.

Once the paste for the meat substitute food product has been prepared, in step 70, it is proceeded to select a process for cooking the prepared cooked conforming the characteristics of the meat substitute food product that is looked for.

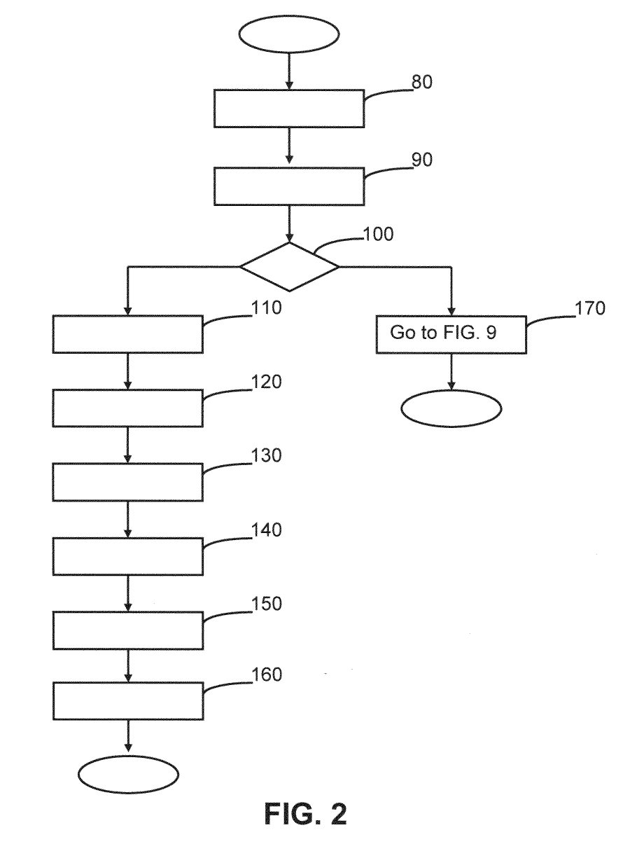

FIG. 2 shows a first embodiment of a process for cooking the prepared paste. In this embodiment, the process starts in step 80, where the prepared paste is dosed in portions that vary within a range from 50 to 150 grams. Said portions of prepared paste are transported and introduced by a conveyor chain to the inside of a oven of the type which has a upper heating panel and a lower heating panel mounted on opposite sides, and spaced from one another, so adjustable, to roll and cook, in a manner generally simultaneous and homogeneous each of the portions of prepared paste, as well their upper and lower surface when in contact with both heating panels so the portions obtain the meat color and texture, all this in step 90. An example of this type of oven which is used in this embodiment is an electric oven TwinGrill Model TWG3600/600 Series 614.

The prepared paste portions for producing meat substitute food products are subject to the following conditions of operation in said oven:
i) The residence time in the oven is about 10 seconds to about 120 seconds;
ii) The temperature of the upper and lower heating panels of the oven should be set from about 100° C. to about 150° C., so the panels can heat the upper and lower conveyor belt of the oven at a range of temperature from about 100° C. to about 150° C.;
iii) The separation between the upper and lower conveyor belts of the oven must be adjusted in a range from 6 mm to 15 mm.

Once the portions of prepared paste for a meat substitute food product has been rolled and cooked, in step 100, it is proceed to select the alternative or alternatives embodiments that is or are appropriate to give a final form to the cooked paste, so that a meat substitute food product is obtained that has a similar presentation to an original meat product. A first alternative, step 110, is that the meat substitute food products obtained through this process of rolling and cooking, in a manner generally simultaneous and homogeneous, are products that are formed automatically with the appearance, for example, of a steak, a cutlet, a skirt steak or cured meat, that in an alternative embodiment, step 120, are marinated in order to obtain a meat substitute with the appearance, for example, to marinated meat; or in an alternative of the embodiment, step 130, are breaded to obtain a meat substitute with the appearance, for example, of breaded skirt steak or breaded veal cutlet, which then can be fried, in step 140, to obtain a meat substitute food product with appearance, for example, of veal escalopes. Then, in step 150, the cooked and formed paste is cooled to reach a temperature of about 10° C. to about 15° C. Alternatively, sauces are added to prepare said cooked and formed paste. Finally, in step 160, the meat substitute food product is packaged.

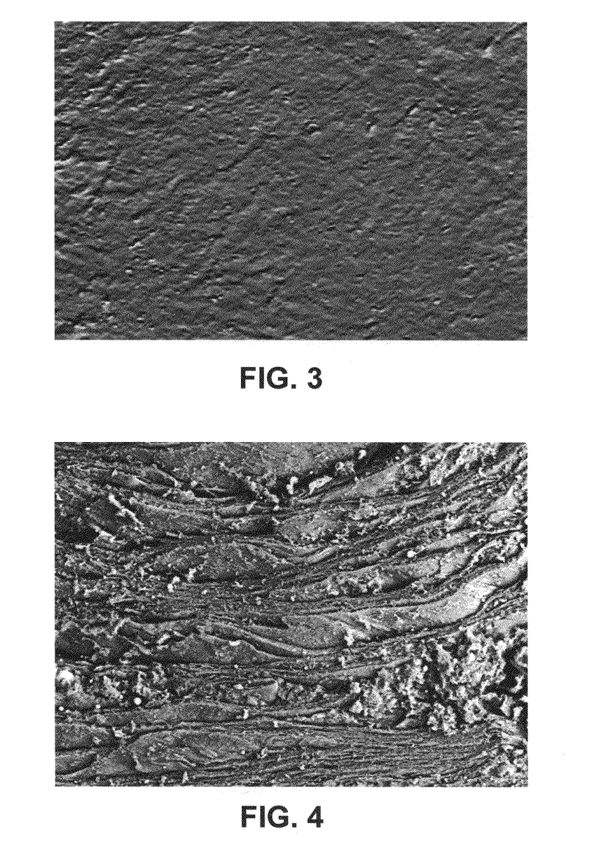

FIG. 3 shows a portion of the surface of the meat substitute food product obtained directly by the rolling and cooking process. On the other hand, FIG. 4 shows a photograph under an electronic microscope amplified to 100× of a view of a substitute meat food product, where the macrofibers are observed with the meat form, and also the microfibrils similar to meat that imply texture attributes related to appearance, touch and sensation in the mouth, and including the interaction of the analogue product with the mouth, as well as flavor, odor, and color similar to meat.

Returning to FIG. 2, other alternatives to give final form to the rolled and cooked paste for a meat substitute food product that has a similar presentation to an original meat product, but not in the form of a steak, a cutlet, a skirt steak or cured beef, are selected in step 170, described below in FIG. 9.

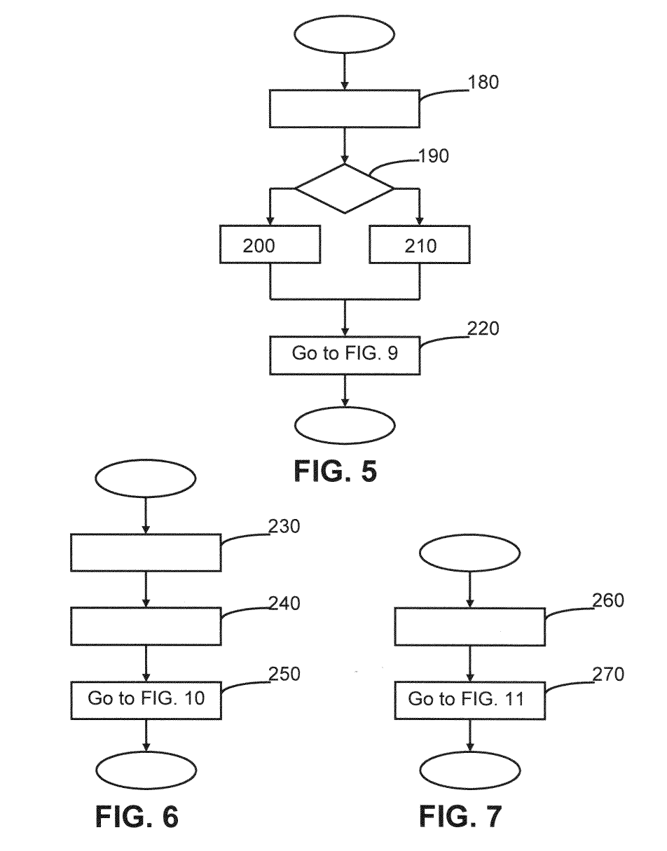

Turning now to FIG. 5, it shows a process of a second embodiment for cook the prepared paste according to the process described above in FIG. 1. In this embodiment, the process starts in step 180, where the prepared paste, at a temperature within the range of 0° C. to 4° C. is extruded or molded so that its fibers are oriented in a manner similar to orientation of meat fibers. Then, in step 190, the extruded or molded paste can only be fried, or fried and cooked to obtain the color and texture of original meat.

In the alternative embodiment of frying the extruded or molded paste, step 200, said embodiment is performed, preferably, in a fryer under the following operating conditions:
i) The residence time in the fryer is of about 10 seconds to about 200 seconds;
ii) The frying temperature is of about 150° C. to about 250° C.;
iii) The molded or extruded paste reaches an internal temperature of about 7° C. to 80° C. in the fryer.

In the alternative embodiment of frying and cooking the extruded or molded paste, step 210, said embodiment is performed, preferably, in a convection oven under the following operating conditions:
i) The residence time in the convection oven is of about 10 seconds to about 200 seconds;
ii) The frying and cooking temperature is of about 130° C. to about 250° C.;
iii) The molded or extruded paste reaches an internal temperature of about 7° C. to 80° C. in the convection oven.

Once the prepared paste for a meat substitute food product has been extruded or molded and cooked, in step 220, it is proceeded to select the alternative or alternatives of the embodiment, described below in FIG. 9, that is or are appropriate to give a final form to the cooked paste, in order to obtain a meat substitute food product that has a similar presentation to an original meat product.

Now in the FIG. 6 is show a process of a third embodiment for cooking the prepared paste according to the process described above in FIG. 1. In this embodiment, the process starts in step 230, where the prepared paste, at a temperature within the range of 0° C. to 4° C., is stuffed in natural or artificial wrappings, edible or inedible, that subsequently, in step 240, the stuffed paste are cooked in oven or cook kettle where the stuffed paste reaches an internal temperature of about 70° C. to about 80° C.

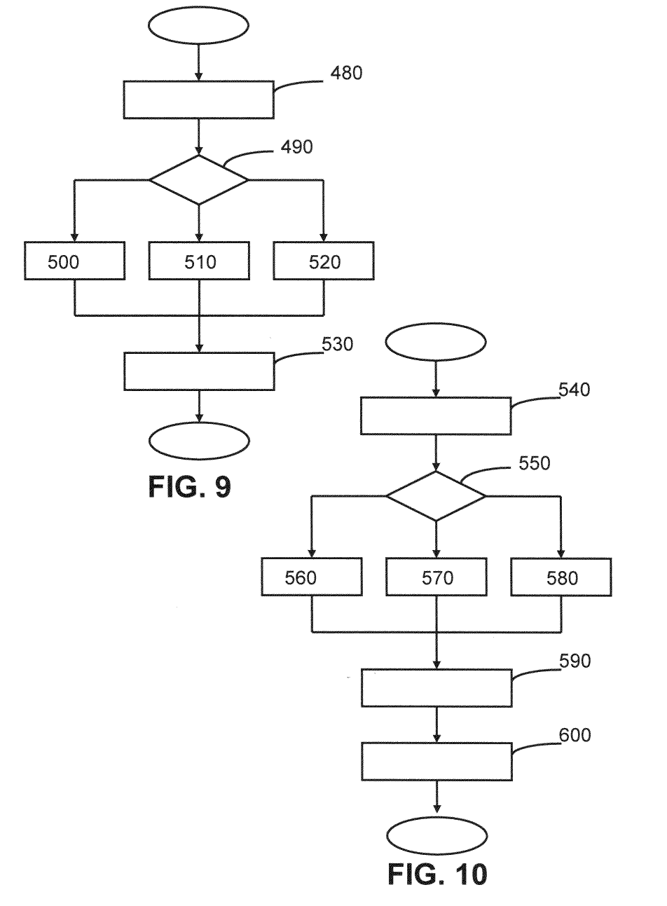

Once the prepared paste for a meat substitute food product has been stuffed and cooked, in step 250, it is proceeded to select the alternative or alternatives of the embodiment, described below in FIG. 10, that is or are appropriate to give a final form to the cooked paste, in order to obtain a meat substitute food product that has a similar presentation to an original meat product.

FIG. 7 shows a process of a fourth embodiment for cooking the prepared paste according to the process described above in FIG. 1. In this embodiment, the process starts in step 260, where the prepared paste is cooked in a cooking pot with stirring it, reaching an internal temperature within the range of about 70° C. to about 80° C.

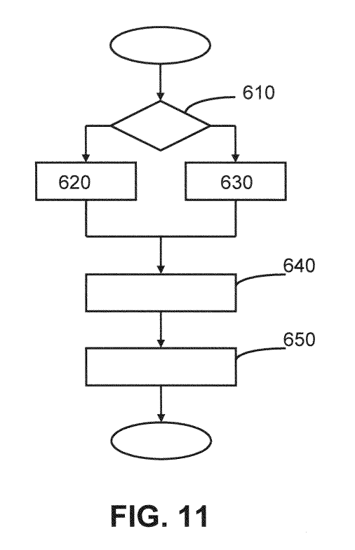

Once the prepared paste for a meat substitute food product has been cooked, in step 270, it is proceeded to select the alternative or alternatives of the embodiment, described below in FIG. 11, that is or are appropriate to give a final form to the cooked paste, in order to obtain a meat substitute food product that has a similar presentation to an original meat product.

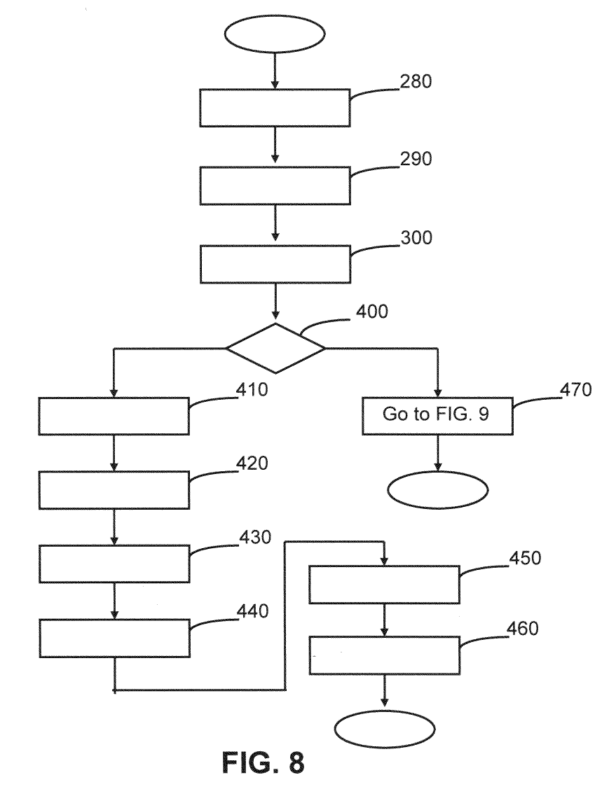

Now in the FIG. 8, it is show a process of a fifth embodiment for cooking the prepared paste according to the process described above in FIG. 1. In this embodiment, the process consists in cooking the prepared paste in successive stages in order to obtain a meat substitute food product, the process starts in step 280, where the prepared paste is dosed in portions that vary within a range from 50 grams to 150 grams. Said portions of prepared paste are transported to a first stage of rolling and cooking, step 290, that is performed inside an oven of the type which has an upper heating panel and a lower heating panel mounted on opposite sides, and spaced from one another, as described above.

Subsequently, in step 300, the rolled and pre-cooked portions are fried in a fryer, or fried and cooked in a convection oven to finish cooking. It is noteworthy that the sequence between the stages of cooking may vary in order of performance and include other stages of cooking.

Once the portions of the prepared paste for a meat substitute food product have been rolled and cooked, in step 400, it is proceeded to select the alternative or alternatives of the embodiment that is or are appropriate to give a final form to the cooked paste, so that a meat substitute food product is obtained that has a similar presentation to an original meat product. A first alternative, step 410, is that the meat substitute food products obtained through this process of rolling and cooking, in a manner generally simultaneous and homogeneous, are products that are formed automatically with the appearance, for example, of steak, cutlet, skirt steak or cured meat, that in an alternative embodiment, in step 420, are marinated in order to obtain a meat substitute with the appearance, for example, of marinated meat; or in an alternative embodiment, step 430, are breaded to obtain a meat substitute with the appearance, for example, of breaded skirt steak or breaded veal cutlet, which then can be fried, in step 440, to obtain a meat substitute food product with the appearance, for example, of veal escalopes. Then, in step 450, the paste that is cooked and formed, is cooled to reach a temperature of about 10° C. to about 15° C. Alternatively, sauces are added to prepare said cooked and formed paste. Finally, in step 460, the meat substitute food product is packaged.

Other alternatives to give the rolled and cooked paste a final form to obtain a meat substitute food product that has a similar presentation to an original meat product, but not in the form of a steak, a cutlet, a skirt steak or cured meat, are selected in step 470, and described below in FIG. 9.

FIG. 9 is a block diagram of alternatives of the embodiment processes to give the cooked paste a form for the processes described above in FIGS. 2, 5, and 8 in order to obtain a similar presentation of a meat product according to this invention. In this embodiment, the process starts in step 480, where the cooked paste is cooled to reach a temperature within the range of about 0° C. to about 15° C. Then, in step 490, the type of form and final presentation is selected for the cooked paste to the market as a substitute meat food product, for example, in step 500, the cooked paste is shredded in a meat shredder to give it the form of shredded meat; or, in step 510, the cooked paste is cut into a food cube cutter to give it the shape of lump meat or meat strips; or, in step 520, the cooked paste is chopped to give it the shape of ground meat. Alternatively, sauces are added to prepare said cooked and formed paste. Finally, in step 530, the meat substitute food product is packaged.

FIG. 10 is a block diagram of alternatives of the processes embodiment to give the cooked paste a shape for the process described above in FIG. 6, and in order to obtain a similar presentation of a meat product according to this invention. In this embodiment, the process starts in step 540, where the cooked paste is cooled to reach a temperature within the range of about 0° C. to about 15° C. Then, in step 550, the type of form and final presentation is selected for the cooked paste for its commercialization on the market as a substitute meat food product, for example, in step 560, the cooked paste is shredded in a meat shredder to give it the form of shredded meat; or, in step 570, the cooked paste is cut into a food cube cutter to give it the shape of lump meat or meat strips; or, in step 580, the cooked paste is chopped to give it the shape of ground meat. Alternatively, the cooked and ground paste is bonded in the form of meatballs. Once the cooked paste receives its shape, it is fried in a fryer under the following operating conditions:
i) The residence time in the fryer is of about 10 seconds to about 200 seconds;
ii) The frying temperature is of about 150° C. to about 250° C.;
iii) The molded or extruded paste reaches an internal temperature of about 70° C. to 80° C. in the fryer.

Then, in step 590, the paste that is cooked and formed, is cooled to reach a temperature of about 0° C. to about 15° C. Alternatively, sauces are added to prepare said cooked and formed paste. Finally, in step 600, the meat substitute food product is packaged.

FIG. 11 is a block diagram of alternatives of the processes embodiment to give the cooked paste a form for the process described above in FIG. 7, and in order to obtain a similar presentation of a meat product according to this invention. In this embodiment, the process starts in step 610, where the type of form and final presentation are selected for the cooked paste for its commercialization on the market as a substitute meat food product, for example, in step 620, the cooked paste is shredded in a meat shredder to give it the form of shredded meat; or, in step 630, the cooked paste is chopped in a meat grinder to give it the shape of ground meat. Alternatively, the cooked and ground paste is bonded in the form of meatballs. Then, in step 640, the paste that is cooked and formed, is cooled to reach a temperature of about 0° C. to about 15° C. Alternatively, sauces are added to prepare said cooked and formed paste. Finally, in step 650, the meat substitute food product is packaged.

### EXAMPLES OF EMBODIMENT

Next, several examples of embodiments are listed, each of which describes how to obtain an exemplary mode different from a meat substitute food product of this invention.

### Example 1

An amount of 500 kg of vegetable protein in the form of pellet is vacuum-hydrated and mixed with 1500 liters of water and 15 kg of caramel color. Hydration and mixing is performed under vacuum during approximately 70 min with the paddles of the mixer rotating at 18 min⁻¹ in alternating cycles of rotation with each cycle lasting about 3 min, the pressure applied is approximately −90 kPa.

Once hydrated and mixed, the vegetable protein is mixed with the following ingredients, added in a dose of:

Beef Fat: 150 kg

Cut Beef: 100 kg

Chicken Paste: 1900 kg

Refined Salt: 45 kg

Sodium Nitrite: 1 kg

Preservatives: 25 kg

The mixture is first performed in a mixer with an open lid during 40 minutes with the paddles of the mixer rotating at 18 min⁻¹ in alternating cycles of rotation with each cycle lasting about 7 min. Next, the mixer is closed to perform a second mixing stage under vacuum, during approximately 20 minutes with the paddles of the mixer rotating at 35 min⁻¹ in alternating cycles of rotation with each cycle lasting about 5 minutes; while the pressure applied is approximately −90 kPa.

Subsequently, 350 kg of texturised units are mixed to the mixture obtained. This mixture is first performed in a mixer with an open lid during approximately 10 minutes with the paddles of the mixer rotating at 18 min⁻¹ in alternating cycles of rotation with each cycle lasting about 3 minutes. Next, the second mixing stage, during approximately 5 minutes, is applied to change the turn of the paddles to 35 min⁻¹ in alternating cycles of rotation with each cycle lasting about 5 minutes. Later, the mixer is closed to perform a third mixing stage under vacuum, during approximately 12 minutes with the paddles of the mixer rotating at 35 min⁻¹ in alternating cycles of rotation with each cycle lasting about 5 minutes; while the pressure applied is approximately −90 kPa. The temperature of the prepared paste is 4° C.

Once prepared, the paste is dosed in portions of 100 gr. These portions of prepared paste to produce meat substitute food products are subject to the following conditions of operation in the electric TwinGrill Modelo TWG3600/600 Series 614 oven:
i) The residence time in oven is of about 70 seconds;
ii) The temperature of the upper and lower heating panels of the oven is of about 120° C.
iii) The separation between the upper and lower conveyor belts of the oven is 10 mm.

The portions of cooked meat substitute food product are cooled to reach a temperature of 8° C. And finally, sauces are added to obtain a food substitute for meat that is packaged. The product thus obtained is shown in FIGS. 3 and 4.

The meat substitute food products obtained by this process of rolling and generally cooked in a manner generally simultaneous and homogeneous, are products that are formed automatically with the appearance, for example, of steak, cutlet, skirt steak or cured meat, which can be marinated to obtain a meat substitute food product with the appearance, for example of marinated meat; or may be breaded in order to obtain a meat substitute food product with the appearance, for example, of breaded skirt steak or breaded veal cutlet, which can then be fried to produce a meat substitute food product with the appearance, for example, of veal escalope. The cooked portions of the meat substitute food product are cooled to reach a temperature of 10° C. And finally, sauces are added to obtain a food substitute for meat that is packaged. The product thus obtained is shown in FIGS. 3 and 4.

### Example 2

With 250 kg of the paste prepared in Example 1, it is proceeded to cook it in a cooking pot by stirring it in three stages of cooking under the following operating conditions:

Temperature of the pot: 40° C.

Cooking time: 10 min

Turning of the pot: 40 min⁻¹

First cooking phase of the pot with the following conditions:

Temperature of the pot (steam): 75° C.

Cooking time: 25 min

Turning of the pot: 10 min⁻¹

Temperature of the paste: 60° C.

Second cooking phase of the pot with the following conditions:

Temperature of the pot (steam): 75° C.

Cooking time: 15 min

Turning of the pot: 30 min⁻¹

Temperature of the paste: 60° C.

Third cooking phase of the pot with the following conditions:

Temperature of the pot (no steam): 75° C.

Cooking Time: 15 min

Turning of the pot: 10 min⁻¹

Temperature of the paste: 72° C.

Once the prepared paste is cooked as a meat substitute food product, it is shredded in a meat shredder to give it the form of shredded meat; that later is cooled to reach a temperature of 8° C. And finally, sauces are added to obtain a food substitute for meat that is packaged.

Based on the embodiments described above, it is considered that the modifications to the environments of these embodiments, as well as to the environments of alternate embodiments will be considered evident for an expert in the state of the art under the present description. Therefore, it is considered that the claims cover those modifications and alternatives that are within the scope of the present invention or its equivalents.

1. A process for preparing meat substitute food products, the process is characterized by comprising the steps of:
hydrating under vacuum at least one vegetable protein mixed with water and at least one colorant;
mixing at least one meat product with said mixture of hydrated and colored vegetable protein;
mixing texturised units of said mixture of meat products and hydrated and colored vegetable protein obtaining a prepared paste;
cooking said prepared paste; and
forming said cooked paste to give it a presentation similar to a meat product.

2. The process of claim 1, characterized because said vegetable protein is fibrous or texturised, whether extruded or hydrated.

3. The process of claim 1, characterized because said vegetable protein is selected from the group consisting of concentrated protein, isolate, flour, pellets, and combinations thereof.

4. The process of claim 1, characterized because said colorant is caramel color.

5. The process of claim 1, characterized because the step of hydrating under vacuum of at least one vegetable protein mixed with water and at least one colorant including the step of:
mixing said vegetable protein, water and colorant in a mixer with paddles spinning clockwise within the range of 10 min⁻¹ to 20 min⁻¹, and counterclockwise each turn within the range of 2 min to 10 min; wherein said mixture is obtained under vacuum during a period within the range of 40 min to 80 min, and at a pressure within the range from −100 kPa to −50 kPa.

6. The process of claim 1, characterized because said meat product is selected from the group consisting of beef, pork, turkey, chicken, beef giblets, pork giblets, turkey giblets, chicken giblets, mechanically deboned beef, mechanically deboned pork meat, mechanically deboned turkey meat, mechanically deboned chicken meat, and combinations thereof.

7. The process of claim 1, characterized because the step of mixing at least one meat product with said hydrated and colored vegetable protein comprising the steps of:
mixing said hydrated and colored vegetable protein with said meat products that are added in a dosed manner in a mixer with paddles spinning clockwise within the range of 10 min⁻¹ to 20 min⁻¹, and counterclockwise each turn within the range of 2 min to 10 min; wherein said mixture is obtained during a period within the range of 15 min to 45 min; and
mixing said meat products with hydrated and colored vegetable protein in a mixer with paddles spinning clockwise within the range of 20 min⁻¹ to 40 min⁻¹, and counterclockwise each turn within the range of 2 min to 10 min; wherein said mixture is obtained under vacuum during a period within the range of 10 min to 20 min, and at a pressure within the range from −100 kPa to −50 kPa.

8. The process of claim 7, characterized because the step of mixing said hydrated and colored vegetable protein with said meat products that are added in a dosed manner in a mixer with paddles spinning clockwise within the range of 10 min⁻¹ to 20 min⁻¹, and counterclockwise each turn within the range of 2 min to 10 min; wherein, said mixture is obtained during a period within the range of 15 min to 45 min; including the step of mixing with preservatives, salt and sodium nitrite.

9. The process of claim 1, characterized because the step of mixing texturised units with said meat products and hydrated and colored vegetable protein, obtaining a prepared paste, comprising the steps of:
mixing said meat products and hydrated and colored vegetable protein with said texturised units in a mixer with paddles spinning clockwise within the range of 10 min⁻¹ to 20 min⁻¹, and counterclockwise each turn within the range of 2 min to 10 min; wherein said mixture is obtained during a period within the range of 5 min to 20 min;
mixing said meat products, hydrated and colored vegetable protein, and said texturised units in a mixer with paddles spinning clockwise within the range of 20 min⁻¹ to 40 min⁻¹, and counterclockwise each turn within the range of 2 min to 10 min; wherein said mixture is obtained during a period within the range of 3 min to 10 min; and
mixing said meat products, hydrated and colored vegetable protein and said texturised units in a mixer with paddles spinning clockwise within the range of 20 min⁻¹ to 40 min⁻¹, and counterclockwise for each turn within the range of 2 min to 10 min; wherein said mixture is obtained under vacuum during a period within the range of 10 min to 20 min, and at a pressure within the range from −100 kPa to −50 kPa.

10. The process of claim 9, further characterized because said mixture of meat products, hydrated and colored vegetable protein, and texturised units is mixed with flavoring units.

11. The process of claim 10, characterized because said flavoring units are selected from the group comprising of meat flavor, pork flavor, turkey flavor, chicken flavor, and combinations thereof.

12. The process of claim 1, further characterized because including the step of extruding said prepared paste at a temperature of about 0° C. to about 4° C.

13. The process of claim 1, characterized because said step of cooking said prepared paste including the steps of:
dosifying said prepared paste; and
rolling and cooking in a manner generally simultaneous and homogeneous said dosified paste, as well on its upper and lower surface in an oven including at least one upper heating panel and at least one lower heating panel, both panels being in contact with said paste to obtain the color and texture of meat.

14. The process of claim 13, characterized because said step of rolling and cooking in a manner generally simultaneous and homogeneous said dosified paste, as well on its upper and lower surface in an oven including at least one upper heating panel and at least one lower heating panel, both panels being in contact with said paste to obtain the color and texture of meat, is performing at a temperature in said upper and lower heating panels from about 100° C. to about 150° C.

15. The process of claim 13, characterized because said step of rolling and cooking in a manner generally simultaneous and homogeneous said dosified paste, as well on its upper and lower surface in an oven including at least one upper heating panel and at least one lower heating panel, both panels being in contact with said paste to obtain the color and texture of meat, is characterized because said cooking is performing with a residence time of said dosified paste in said oven of about 10 seconds to about 120 seconds.

16. The process of claim 13, characterized because said step of rolling and cooking in a manner generally simultaneous and homogeneous said dosified paste, as well on its upper and lower surface in an oven including at least one upper heating panel and at least one lower heating panel, both panels being in contact with said paste to obtain the color and texture of meat, is characterized because said cooking of said dosified paste is performing with a separation between the upper and lower heating panels from about 6 mm to about 15 mm.

17. The process of claim 13, characterized because a meat substitute food product is obtained with an appearance of steak, cutlet, skirt steak, or cured steak.

18. The process of claim 17, further characterized because including the step of breading said meat substitute food product with the appearance of a cutlet or skirt steak for obtaining a meat substitute food product with an appearance of a breaded veal cutlet or breaded skirt steak.

19. The process of claim 18, further characterized because including the step of frying said meat substitute food product with the appearance of a breaded veal cutlet or breaded skirt steak for obtaining a meat substitute food product with an appearance of veal escalope.

20. The process of claim 1, characterized because said step of cooking said prepared paste including the steps of:
extruding or molding said prepared paste, so that the fibers of said prepared paste are oriented in a similar manner as the orientation of the fibers of meat; and
frying, or frying and cooking the extruded or molded paste for obtaining the color and texture of meat.

21. The process of claim 20, characterized because said step of frying said extruded or molded paste is performing in a fryer at a temperature of about 150° C. to about 250° C.

22. The process of claim 21, characterized because a residence time of said extruded or molded paste, in said fryer is from about 10 seconds to about 200 seconds.

23. The process of claim 21, characterized because said extruded or molded paste reaches an internal temperature of about 70° C. to about 80° C. in said fryer.

24. The process of claim 20, characterized because said step of frying and cooking said extruded or molded paste is performing in a convection oven at a temperature of about 130° C. to about 250° C.

25. The process of claim 24, characterized because said extruded or molded paste reaches an internal temperature of about 70° C. to about 80° C. in said convection oven.

26. The process of claim 1, characterized because said step of cooking said prepared paste including the steps of:
stuffing said prepared paste; and
cooking said stuffed paste in an oven or cook kettle.

27. The process of claim 26, characterized because said prepared paste is stuffed in natural or artificial, edible or inedible wrappings.

28. The process of claim 26, characterized because in said step of cooking said stuffed paste in an oven or cook kettle, the stuffed paste reaches an internal temperature of about 70° C. to about 80° C.

29. The process of claim 26, further characterized because including the step of frying said cooked paste once it is formed for producing a presentation similar to a meat product.

30. The process of claim 1, characterized because said step of cooking said prepared paste including the step of cooking said prepared paste in a cooking pot while stirring said paste.

31. The process of claim 30, characterized because in said step of cooking said prepared paste in a cooking pot while stirring it, said prepared paste reaches an internal temperature of about 70° C. to about 80° C.

32. The process of claim 1, characterized because said step of forming said cooked paste to give it a presentation similar to a meat product, including the steps of:
cooling said cooked paste; and
shredding said cooked paste in a shredding machine to give it a shredded meat shape; or
cutting said cooked paste in a food cube cutter to give it a meat shape of lump meat or meat strips type, or
grinding said cooked paste in a meat mill to give it a ground meat shape.

33. The process of claim 32, characterized because in said step of cooling said cooked paste, said cooked paste reaches a temperature of about 0° C. to about 15° C.

34. The process of claim 32, characterized because said step of grinding said cooked paste in a meat mill to give it a ground meat shape, further including the step of forming meatballs.

35. The process of claim 1, further characterized because including the step of adding sausages for seasoning said formed paste.

36. The process of claim 1, characterized because said step of cooking said prepared paste can be performed in various stages of cooking, selected from the group consisting of rolling and cooking in an oven including at least one upper heating panel and at least one lower heating panel, frying in a fryer, frying and cooking in a convection oven, and combinations thereof.

37. A paste for preparing meat substitute food products, said paste is characterized by comprising:
at least one hydrated vegetable protein;
at least one colorant;
at least one meat product; and
flavoring units and texturised units.

38. The paste of claim 37, characterized because said vegetable protein is fibrous or texturised, whether extruded or hydrated.

39. The process of claim 37, characterized because said vegetable protein is selected from the group consisting of concentrated protein, isolates, flours, pellets, and combinations thereof.

40. The paste of claim 37, characterized because said colorant is caramel color.

41. The paste of claim 37, characterized because said meat product is selected from the group consisting of beef, pork, turkey, chicken, beef giblets, pork giblets, turkey giblets, chicken giblets, mechanically deboned beef, mechanically deboned pork, mechanically deboned turkey, mechanically deboned chicken, and combinations thereof.

42. The paste of claim 37, characterized because said flavoring units are selected from the group consisting of meat flavor, pork flavor, turkey flavor, chicken flavor, and combinations thereof.

43. The paste of claim 37, further characterized because including preservatives, salt and sodium nitrite.

44. A process for preparing a paste for preparing a meat substitute food product, the process is characterized by comprising the steps of
hydrating under vacuum at least one vegetable protein mixed with water and at least one colorant;
mixing at least one meat product with said mixture of hydrated and colored vegetable protein; and
mixing texturised units to said mixture of meat products and hydrated and colored vegetable protein for obtaining a prepared paste.

45. The process of claim 44, characterized because said vegetable protein is fibrous or texturised, whether extruded or hydrated.

46. The process of claim 44, characterized because said vegetable protein is selected from the group consisting of concentrated protein, isolates, flours, pellets, and combinations thereof.

47. The process of claim 44, characterized because said colorant is caramel color.

48. The process of claim 44, characterized because said step of hydrating under vacuum at least one vegetable protein mixed with water and at least one colorant including the step of:
mixing said vegetable protein, water, and colorant in a mixer with paddles spinning clockwise within the range of 10 min⁻¹ to 20 min⁻¹, and counterclockwise for each turn within the range of 2 min to 10 min; wherein said mixture is obtained under vacuum during a period within the range of 40 min to 80 min, and at a pressure within the range from −100 kPa to −50 kPa.

49. The process of claim 44, characterized because said meat product is selected from the group consisting of beef, pork, turkey, chicken, beef giblets, pork giblets, turkey giblets, chicken giblets, mechanically deboned beef, mechanically deboned pork meat, mechanically deboned turkey meat, mechanically deboned chicken meat, and combinations thereof.

50. The process of claim 44, characterized because said step of mixing at least one meat product with said hydrated and colored vegetable protein including the steps of:
mixing said hydrated and colored vegetable protein with said meat products that are added in a dosed manner in a mixer with paddles spinning clockwise within the range of 10 min⁻¹ to 20 min⁻¹, and counterclockwise for each turn within the range of 2 min to 10 min; wherein said mixture is obtained during a period within the range of 15 min to 45 min; and
mixing said mixture of meat products with a hydrated and colored vegetable protein in a mixer with paddles spinning clockwise within the range of 20 min⁻¹ to 40 min⁻¹, and counterclockwise for each turn within the range of 2 min to 10 min; wherein said mixture is obtained under vacuum during a period within the range of 10 min to 20 min, and at a pressure within the range from −100 kPa to −50 kPa.

51. The process of claim 50, characterized because said step of mixing said hydrated and colored vegetable protein with said meat products are added in a dosed manner in a mixer with paddles spinning clockwise within the range of 10 min⁻¹ to 20 min⁻¹, and counterclockwise for each turn within the range of 2 min to 10 min; wherein said mixture is obtained during a period within the range of 15 min to 45 min; including the step of mixing with preservatives, salt, and sodium nitrite.

52. The process of claim 44, characterized because said step of mixing texturised units with said meat products and hydrated and colored vegetable protein for obtaining a prepared paste, including the steps of
mixing said mixture of meat products and hydrated and colored vegetable protein with said texturised units in a mixer with paddles spinning clockwise within the range of 10 min⁻¹ to 20 min⁻¹, and counterclockwise each turn within the range of 2 min to 10 min; wherein said mixture is obtained during a period within the range of 5 min to 20 min;
mixing said mixture of meat products, hydrated and colored vegetable protein, and said texturised units in a mixer with paddles spinning clockwise within the range of 20 min⁻¹ to 40 min⁻¹, and counterclockwise each turn within the range of 2 min to 10 min; wherein said mixture is obtained during a period within the range of 3 min to 10 min; and
mixing said mixture of meat products, hydrated and colored vegetable protein and said texturised units in a mixer with paddles spinning clockwise within the range of 20 min⁻¹ to 40 min⁻¹, and counterclockwise for each turn within the range of 2 min to 10 min; wherein said mixture is obtained under vacuum during a period within the range of 10 min to 20 min, and at a pressure within the range from −100 kPa to −50 kPa.

53. The process of claim 52, further characterized because said mixture of meat products, hydrated and colored vegetable protein, and texturised units is mixed with flavoring units.

54. The process of claim 53, characterized because said flavoring units are selected from a group consisting of meat flavor, pork flavor, turkey flavor, chicken flavor, and combinations thereof.

55. A cooked meat substitute food product, characterized by comprising:
at least one hydrated vegetable protein;
at least one colorant;
at least one meat product; and
flavoring units and texturised units.

56. The product of claim 55, characterized because said vegetable protein is fibrous or texturised, whether extruded or hydrated.

57. The product of claim 55, characterized because said vegetable protein is selected from the group consisting of concentrated protein, isolates, flours, pellets, and combinations thereof.

58. The product of claim 55, characterized because said colorant is caramel color.

59. The product of claim 55, characterized because said meat product is selected from the group consisting of beef, pork, turkey, chicken, beef giblets, pork giblets, turkey giblets, chicken giblets, mechanically deboned beef, mechanically deboned pork meat, mechanically deboned turkey meat, mechanically deboned chicken meat, and combinations thereof.

60. The product of claim 55, characterized because said flavoring units are selected from a group consisting of meat flavor, pork flavor, turkey flavor, chicken flavor, and combinations thereof.

61. The product of claim 55, further characterized because including preservatives, salt, and sodium nitrite.

62. The product of claim 55, characterized because said product has the appearance of a steak, a cutlet, a skirt steak, or cured beef.

63. The product of claim 55, further characterized because including an agent for coating in breadcrumbs.

64. The product of claim 63, characterized because said product has the appearance of a breaded veal cutlet or breaded skirt steak.

65. The product of claim 63, further characterized because said product is fried.

66. The product of claim 65, characterized because said product has the appearance of a veal escalope.

67. The product of claim 55, characterized because said product is rolled, molded, fried, or fried and cooked.

68. The product of claim 55, characterized because said product has the appearance of shredded meat, ground meat, lump meat, meat strips, or meatballs.
